(19) United States
(12) Patent Application Publication
(10) Pub. No.: US 2025/0123527 A1
(43) Pub. Date: Apr. 17, 2025

(54) EC DIMMING DEVICE WITH THIN CELL SPACING

(71) Applicant: Gentex Corporation, Zeeland, MI (US)

(72) Inventors: Garret C. DeNolf, Grand Rapids, MI (US); Xiaoxu Niu, Grand Rapids, MI (US); Patrick K. Kreun, Zeeland, MI (US); Danny L. Minikey, JR., Fenwick, MI (US); Autumn W. Goulet, Caledonia, MI (US); Adam R. Heintzelman, Grand Rapids, MI (US); Juan C. Lara, Holland, MI (US); Ryan Barrido Balili, Holland, MI (US)

(73) Assignee: Gentex Corporation, Zeeland, MI (US)

(21) Appl. No.: 18/912,993

(22) Filed: Oct. 11, 2024

Related U.S. Application Data
(60) Provisional application No. 63/543,784, filed on Oct. 12, 2023.

(51) Int. Cl. G02F 1/161; G02F 1/155

(52) U.S. Cl. CPC G02F 1/161; G02F 1/155

(57) ABSTRACT

An electro-optic element includes a first substrate that has a first surface and a second surface. A second substrate has a third surface and a fourth surface, the second substrate is disposed in a spaced apart relationship with the first substrate such that the second and third surfaces face one another. A first electrode is associated with the second surface and a second electrode is associated with the third surface. An electrochromic medium is disposed between the first and second electrodes. An outer seal is disposed between the first and second substrates in a peripheral manner to contain the electrochromic medium. The outer seal is substantially uniform and defines a completely closed loop.

### CROSS-REFERENCE TO RELATED APPLICATION

This application claims priority to and the benefit under 35 U.S.C. § 119(e) of U.S. Provisional Application No. 63/543,784, filed on Oct. 12, 2023, entitled “EC DIMMING DEVICE WITH THIN CELL SPACING,” the disclosure of which is hereby incorporated herein by reference in its entirety.

### FIELD OF THE DISCLOSURE

The present disclosure generally relates to an electro-optic element that includes a continuous, closed loop outer seal without a fill port.

### SUMMARY OF THE DISCLOSURE

According to one aspect of the present disclosure, an electro-optic element includes a first substrate that has a first surface and a second surface. A second substrate has a third surface and a fourth surface, the second substrate is disposed in a spaced apart relationship with the first substrate such that the second and third surfaces face one another. A first electrode is associated with the second surface and a second electrode is associated with the third surface. An electrochromic medium is disposed between the first and second electrodes. An outer seal is disposed between the first and second substrates in a peripheral manner to contain the electrochromic medium. The outer seal is substantially uniform and defines a completely closed loop.

According to another aspect of the present disclosure, a window includes a first substrate that has a first surface and a second surface. A second substrate has a third surface and a fourth surface, the second substrate is disposed in a spaced apart relationship with the first substrate such that the second and third surfaces face one another. A first electrode is associated with the second surface and a second electrode is associated with the third surface. An electrochromic medium is disposed between the first and second electrodes. The electrochromic medium includes traces of an inner seal material that has been dissolved in the electrochromic medium. An outer seal formed of an outer seal material is disposed between the first and second substrates in a peripheral manner to contain the electrochromic medium. The outer seal is substantially uniform and defines a completely closed loop.

According to yet another aspect of the present disclosure, an electro-optic element includes a first substrate that has a first surface and a second surface. A second substrate has a third surface and a fourth surface, the second substrate is disposed in a spaced apart relationship with the first substrate such that the second and third surfaces face one another. A first electrode including an anodic film is associated with the second surface and a second electrode including a cathodic film is associated with the third surface. An electrochromic medium is disposed between the first and second electrodes. The electrochromic medium includes an electrolyte having traces of an inner seal material that has been dissolved in the electrochromic medium. An outer seal formed of an outer seal material is disposed between the first and second substrates in a peripheral manner to contain the electrochromic medium. The outer seal is substantially uniform and defines a completely closed loop.

According to still another aspect of the present disclosure, a process for manufacturing an electro-optic element includes providing a substrate, disposing an inner seal in a peripheral manner on the substrate, and disposing an outer seal in a peripheral manner on the substrate. The inner seal is located within the outer seal. The process further includes disposing an electrochromic medium within the inner seal and disposing another substrate on top of the substrate, inner seal, outer seal, and electrochromic medium. The process further includes curing the outer seal.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side cross-sectional view of an electro-optic element with an internal seal, according to an aspect of the present disclosure;

FIG. 2 is a plan view of an electro-optic element, according to an aspect of the present disclosure;

FIG. 3 is a side cross-sectional view of an electro-optic element with an internal seal that has been dissolved, according to an aspect of the present disclosure;

FIG. 4 is an enlarged partial-cross-sectional view of an electrochromic medium with spacer elements dissolved over a period of time, according to an aspect of the present disclosure; and

FIG. 5 is a flow chart of a process for manufacturing an electro-optic element, according to an aspect of the present disclosure.

### DETAILED DESCRIPTION

The present illustrated embodiments reside primarily in combinations of method steps and apparatus components related to an electro-optic element that includes a continuous, closed loop outer seal without a fill port. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

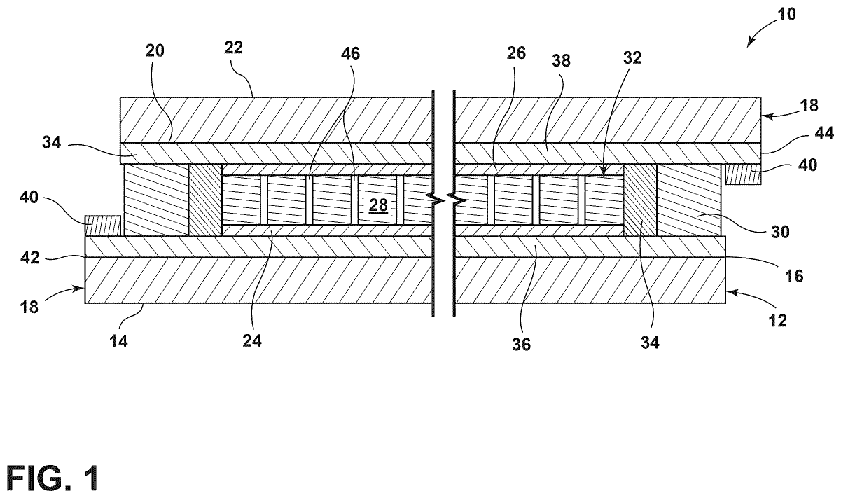

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring initially to FIG. 1, reference numeral 10 designates an electro-optic element. The electro-optic element 10 includes a first substrate 12 that has a first surface 14 and a second surface 16. A second substrate 18 has a third surface 20 and a fourth surface 22, the second substrate 18 is disposed in a spaced apart relationship with the first substrate 12 such that the second and third surfaces 16, 20 face one another. A first electrode 24 is associated with (e.g., located on or integral with) the second surface 16 and a second electrode 26 is associated with (e.g., located on or integral with) the third surface 20. An electrochromic medium 28 is disposed between the first and second electrodes 24, 26. An outer seal 30 is disposed between the first and second substrates 12, 18 in a peripheral manner to contain the electrochromic medium 28. The outer seal 30 is substantially uniform and defines a completely closed loop.

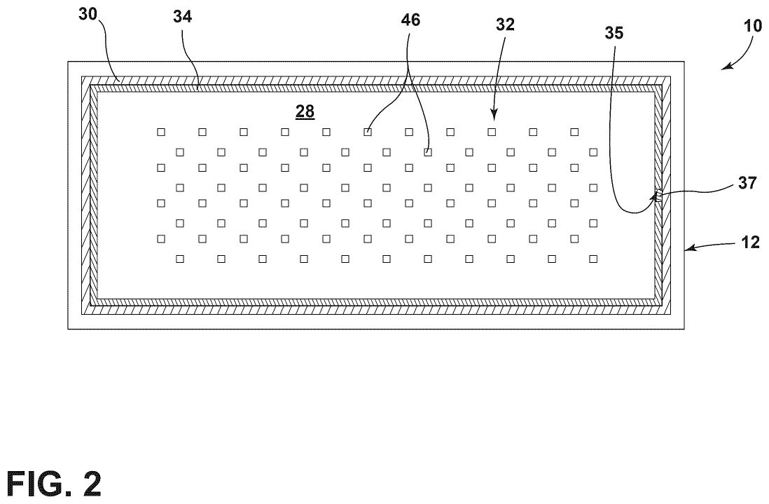

With reference now to FIGS. 1 and 2, the outer seal 30 defines a completely closed loop such that an impermeable cavity 32 is formed between the outer seal 30, and the first and second electrodes 24, 26. In other words, the outer seal 30 does not define a fill port or require a plug member that can cause unwanted oxidation or other effects on the electrochromic medium 28. An inner seal 34 is located internally to the loop defined by the outer seal 30. The inner seal 34 may be formed of a material compatible with the electrochromic medium 28. More particularly, the inner seal 34 may be formed of a material that can be dissolved within the electrochromic medium 28 without negative impacts to aesthetics, performance, and environmental factors. The electro-optic element 10 may be configured to have low current requirements and hold specific transmission states within a variety of different transmission states. The different transmission states are achieved by applying a specific external electrical potential to the electro-optic element 10 (e.g., the first and second electrodes 24, 26).

In some embodiments, a first conductive layer 36 is located between the first substrate 12 and the first electrode 24 and a second conductive layer 38 is located between the second substrate 18 and the second electrode 26. The first and second conductive layers 36, 38 receive and distribute an applied voltage on the first and second electrodes 24, 26, respectively. More particularly, the conductive layers 36, 38 may be in electrical communication with a power source through one or more conductive intermediaries. In some implementations, the conductive layers 36, 38 may be formed of transparent conductive oxides (TCOs) such as fluorine doped tin oxide (FTO), for example TEC™ glass, indium tin oxide (ITO), doped zinc oxide, indium zinc oxide (IZO), aluminum doped zinc oxide (AZO), metal oxide/metal/metal oxide (including, where the metal oxide can be substituted with metal carbide, metal nitride, metal sulfide, etc.), nanowires, wire mesh, and polymer/carbon based conductors. The conductive intermediaries may be formed of conductive tape, conductive adhesive, conductive inks, clips, buses, traces, or wires. The first and/or second substrates 12, 18 can be made of glass, plastic, or other optically transparent or translucent material(s), non-limiting examples of which include borosilicate glass, soda lime glass, or polymeric materials, such as natural and synthetic polymeric resins, plastics, and/or composites.

With continued reference to FIGS. 1 and 2, the applied voltage results in an absorbance change of the electro-optic element 10, thus impacting transmissiveness resulting in dimming and undimming the electro-optic element 10. The different transmission states remain stable over an extended period of time when the electro-optic element is left at an open circuit state. The first and second electrodes 24, 26 may be alternatively referred to herein as anodic or cathodic layers 24, 26. In this manner, the first electrode 24 may configured as one of an anodic film or a cathodic film while the second electrode 26 may be configured as the other of the anodic film and the cathodic film. The anodic and cathodic films may be configured as homogenous layers with substantially uniform concentrations of either anodic species or cathodic species. The electrochromic medium 28 may be an electrolyte. The change in charge of each electrode 24, 26 from the injection and removal of electrons (cathodic and anodic, respectively) is offset by migration of electrolyte counter ions located in the electrochromic medium 28 between the two layers or films.

With continued reference to FIGS. 1 and 2, in some implementations, the electrodes 24, 26 may include conductive nanowire coating, a conductive metal mesh, an insulator/metal/insulator stack (IMI stack), a transparent polymer filled with nanoparticles (such as indium tin oxide particles), carbon nanotubes, graphene, or a conductive polymer (which may be integral to first and second substrates 12, 18). As such, in these embodiments, the conductive layers 36, 38 may be optional (i.e., not present in the electro-optic element 10). The electrochromic medium 28 may contain at least a cathodic material (i.e., a material that is reducible), an anodic material (i.e., a material that is oxidizable), or a mixture of a cathodic material and an anodic material. The electrochromic medium 28 may be a solid state, solution phase, a gel, or a polymer-based material such as a thermoplastic material, and/or a cross-linked material. One or both of the cathodic and anodic materials may be confined to one or both of the first and second substrates 12, 18 and/or electrodes 24, 26. The electrochromic medium 28 may also contain an electrolyte to facilitate charge movement between electrodes 24, 26 (e.g., the anodic and cathodic films).

The conductive intermediary may include an electric bus 40. The electric bus 40 may include segments that at least partially travel along a peripheral edge of the cavity 32 on the first conductive layer 36 and the second conductive layer 38 and/or electrodes 24, 26. In some implementations, the electric bus 40 may extend along the entire peripheral edge of the conductive layers 36, 38 and/or electrodes 24, 26 and be in operable communication to the power source. For example, the electric bus 40 may include a conductive adhesive, tape, and/or the like, that may include a higher electric conductivity than one or both of the first and second conductive layers 36, 38 and/or electrodes 24, 26. The electric bus 40 may include segments placed on an internal surface of one (e.g., a surface that faces towards the cavity 32) of the first conductive layer 36 and/or the second conductive layer 38, and/or the electric bus 40 may include segments placed on an outer surface (e.g., a surface that faces away from the cavity 32) of the first conductive layer 36 and/or the second conductive layer 38. In other implementations without the conductive layers 36, 38, the electric bus 40 may include segments placed on an internal surface (e.g., a surface that faces towards the cavity 32) of the first electrode 24 and/or the second electrode 26, and/or the electric bus 40 may include segments placed on an outer surface (e.g., a surface that faces away from the cavity 32) of the first electrode 24 and/or the second electrode 26. In some implementations, the electric bus 40 may include a first single segment (e.g., a first continuous piece) that transverses an entire outboard perimeter of the cavity 32 on the first conductive layer 36 and/or the first electrode 24 and a second single segment (e.g., second continuous piece) that transverses an entire outboard perimeter of the cavity 32 on the second conductive layer 38 and/or the second electrode 26. In some implementations, segments of the electric bus 40 may be localized to one or more alternative locations and/or in combinations of any of the above-described implementations.

With continued reference to FIGS. 1 and 2, in some implementations, a first peripheral edge of the first substrate 12 and a second peripheral edge of the second substrate 18 may be misaligned such that the first substrate 12 defines a first overhang portion 42 that extends past the second peripheral edge, and the second substrate 18 defines a second overhang portion 44 that extends past the first peripheral edge. In some embodiments, the first conductive layer 36 may extend along part of the first overhang portion 42 and a segment of the electric bus 40 may be at least partially located on the first conductive layer 36 over the first overhang portion 42. In some embodiments, the second conductive layer 38 may extend along part of the second overhang portion 44 and a segment of the electric bus 40 may be at least partially located on the second conductive layer 38 over the second overhang portion 44. However, it should be appreciated that, in some embodiments, the substrates 12, 18 may be aligned (i.e., without overhang portions 42, 44). In some embodiments, the electric bus 40 may be located between the outer seal 30 or the inner seal 34 and one of the substrates 12, 18.

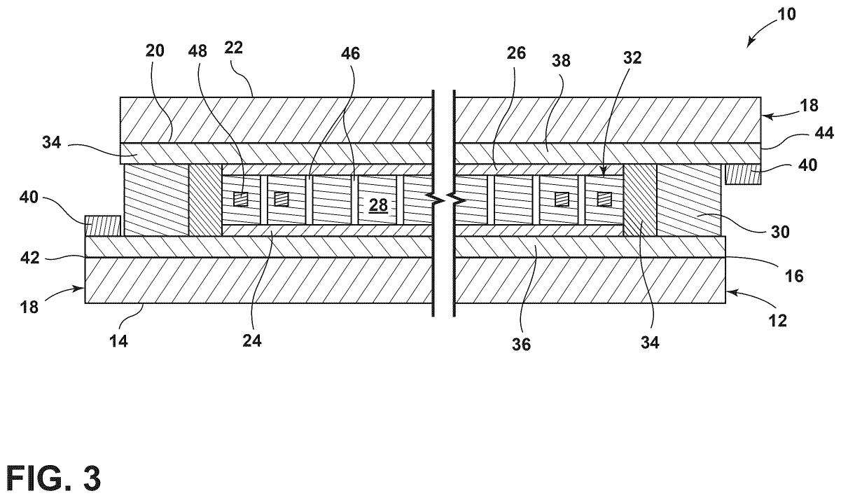

With reference now to FIGS. 2 and 3, the outer seal 30 may include a substantially uniform and continuous loop outlining a periphery of the cavity 32 to retain the electrochromic medium 28, the first electrode 24, and the second electrode 26 between the first substrate 12 and the second substrate 18 in an inboard direction. More particularly, the outer seal 30 may be substantially uniform in a manner in which the outer seal 30 does not include any breaks or holes, such as fill ports or plugs, has a substantially uniform cross-section within manufacturing capabilities, and/or the like. In other words, the electrochromic medium 28 is not inserted into the cavity 32 through the outer seal 30 and therefore the outer seal 30 can be substantially uniform (e.g., in cross-section) and homogenous (e.g., in its entirety). The substantially uniformness of the outer seal 30 facilitates depositing the outer seal 30 in a completely closed loop, without any breaks or holes as described above. Similarly, it should be appreciated that the first and second substrates 12, 18 or any other structures of the electro-optic element 10 may not include any fill ports or plugs (e.g., may be substantially uniform without fill ports). In this manner, the electrochromic medium 28 can be placed in the cavity 32 without utilizing any fill ports. Stated another way, the cavity 32 defined between the outer seal 30 and the first and second substrates 12, 18 may be impermeable to, for example, the electrochromic medium 28, fluids, moisture, and air. The outer seal 30 may have an outer seal material, such as an epoxy, acrylic, and/or the like to provide low oxygen and moisture permeability. The outer seal 30 may be located inboard from the electric bus 40. In other words, the first conductive layer 36 and/or the second conductive layer 38 may include outer peripheral edges that extend past the outer seal 30. For example, the outer seal 30 may be located inboard of both the first overhang portion 42 and the second overhang portion 44 and spaced inboard from the electric bus 40. However, it should be appreciated that, in other arrangements, the outer seal 30 may substantially cover and/or be aligned (e.g., fully or partially) with the electric bus 40 or be located elsewhere.

The inner seal 34 is located inboard from the outer seal 30. While the inner seal 34 may define an initial outboard perimeter of the cavity 32 to retain the electrochromic medium 28, the inner seal 34 may be configured to be dissolved within the electrochromic medium 28 after assembly. In other words, the inner seal 34 may primarily serve the function to retain the electrochromic medium 28 and prevent the electrochromic medium 28 from contacting or otherwise interacting with the outer seal 30 until the outer seal 30 has been cured. The outer seal 30 and the inner seal 34 may be proximate (e.g., less than 1 mm, less than 2 mm, less than 3 mm, less than 4 mm, less than 5 mm, less than 10 mm, between about 1 mm and 10 mm, between about 0.5 mm and 5 mm, or between about 1 mm and 3 mm) or in direct contact. In this manner, once the electro-optic element 10 has been assembled and the inner seal 34 is dissolved, the cavity 32 will be defined by the outer seal 30. The inner seal 34 may be formed of an inner seal material that is different than the outer seal material. The inner seal material is compatible with the electrochromic medium 28 (e.g., dissolvable in the electrolyte). In this manner, after the inner seal 34 has been dissolved, traces 48 of the inner seal material may be present in the electrochromic medium 28. The inner seal material may include an acrylic material such as photo-crosslinked polymethyl methacrylate (“PMMA”), epoxy material such as an SU-8 epoxy, and/or the like.

As best depicted in FIGS. 1 and 2, the inner seal 34 may, like the outer seal 30, be substantially uniform and completely closed looped in a manner in which the inner seal 34 does not include any breaks or holes, such as fill ports or plugs, has a substantially uniform cross-section within manufacturing capabilities. However, in other implementations and depending on manufacturing processes, the inner seal 34 may define a fill port 35 and a plug 37 that the electrochromic medium 28 is injected into (e.g., prior to depositing the outer seal 30).

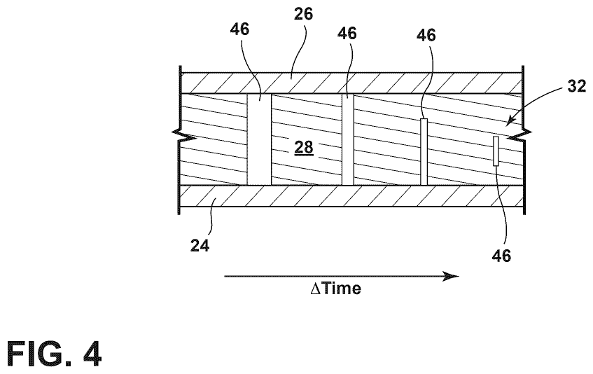

With reference now to FIG. 4, the inner seal material may be compliant (e.g., deformable and/or with elastic memory), such that the inner seal 34 does not impact cell spacing (e.g., a distance between second and third surfaces 16, 20). The cell spacing may be set and maintained by the outer seal 30, components within the outer seal (e.g., beads or other spacer shapes), and/or additional elements. For example, a plurality of spacer elements 46 may be located within the cavity 32. The spacer elements 46 may be formed of a spacer material that either dissolves over time within the electrochromic medium 28 or, alternatively, retains a shape over an operable life of the electro-optic element 10. For example, the spacer elements 46 may be formed of a polymer material, a polymer photo-spacer material, an acrylic material such as PMMA, UV-curable material, epoxy material such as an SU-8 epoxy (e.g., dissolvable, for example, within the electrolyte), or the inner seal material with different degrees of cross-linking that maintains shape or dissolves only after the cell spacing has been achieved and the outer seal 30 is cured. In some embodiments, the spacer elements 46 are formed with a material that can be dissolved or otherwise broken down under a different principle than the inner seal 34 (e.g., thermal, UV, and/or the like). It should be appreciated that the first and second substrates 12, 18 may be formed of glass (e.g., soda-lime glass or borosilicate glass), plastics, ceramics, metal, combinations thereof, and/or the like. It should also be appreciated that the first and second substrates 12, 18 may be flat, requiring a plurality of the spacer elements 46 of uniform size, or not flat (e.g., bent, curved, or combinations of these shapes), requiring a plurality of the spacer elements 46 of non-uniform sizes. In various embodiments, the electro-optic element 10 may be implemented in a window, display device, sunroof, optical filter, eyeglasses, mirrors, and a variety of other applications with vehicle, aircraft, transportation, VR and mixed reality and other applications that may benefit from varying a transmittance of light through the electro-optic element 10.

With reference now to FIG. 4, a process 200 for manufacturing an electro-optic element 10 is provided. At step 202, the process 200 includes providing a substrate (e.g., the first or second substrate 12, 18). At step 204 the process 200 includes depositing an inner seal 34 in a peripheral manner on the substrate 12, 18 and depositing an outer seal 30 in a peripheral manner on the substrate 12, 18 such that the inner seal 34 is located within the outer seal 30. More particularly, the outer seal 30 may be deposited in a substantially uniform and completely closed looped (e.g., without a fill port, break, hole, or plug) and the inner seal 34 may be located inboard (e.g., within) the closed loop. At step 206, the process 200 may include providing spacer elements 46 on the substrate 12, 18 (e.g., the second surface 16 or the third surface 20) to define cell spacing. Step 206 may include at 208, forming the spacer elements 46 via a spraying process, a photolithography process, and/or the like. Steps 206 and 208 may be completed before any of steps 202-204 or at the same time as step 204. In some implementations, step 204 may be completed initially before step 208, followed by step 206, and step 202 may be completed before or after any of steps 204-208.

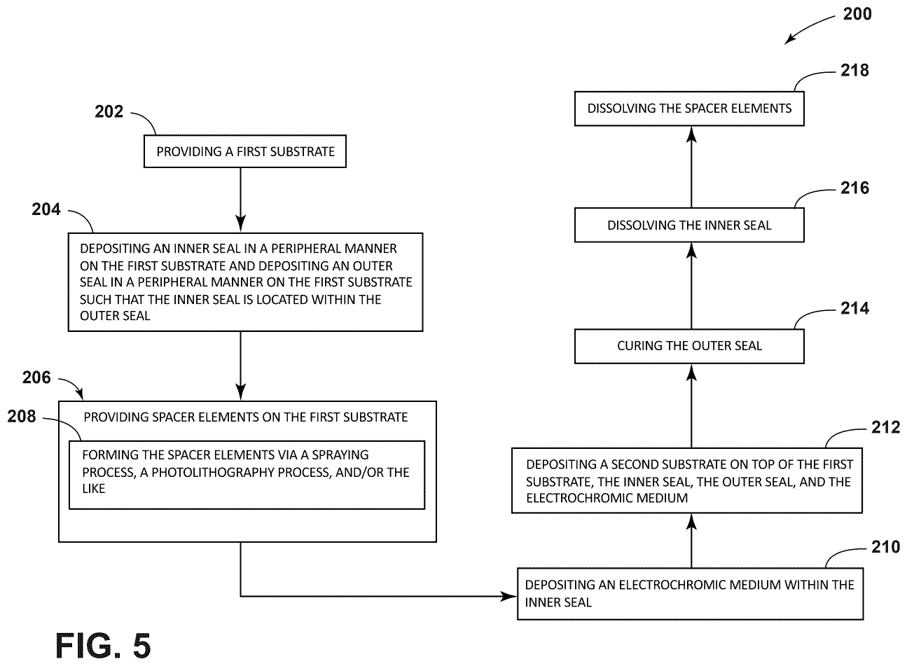

With continued reference to FIG. 5, the process 200 further includes, at step 210, depositing an electrochromic medium 28 within the inner seal 34. In this manner, the electrochromic medium 28 is prevented from contacting the outer seal 30. In some implementations, step 202 may occur after step 210. At step 212, the process 200 includes depositing another substrate 18 (e.g., the other of the first or second substrate 12, 18) on top of the substrate 12, 18, inner seal 34, outer seal 30, and electrochromic medium 28. It should be appreciated that, in some embodiments, the step of depositing the outer seal 30 and/or the spacer elements 46 may alternatively include deposition on the second substrate 18, rather than the first substrate 12, prior to step 212. In some implementations, part of step 204, where the outer seal 30 is deposited may occur, for example, after the step 212 and step 210 may include depositing the electrochromic medium 28 into the fill port 35 of the inner seal 34 and plugging the fill port 35 with a plug 37 before depositing the outer seal 30. At step 214, the process 200 includes curing the outer seal 30. At step 216, the process 200 includes dissolving the inner seal 34. For example, the inner seal 34 may be dissolved or otherwise broken down over time by exposure to the electrochromic medium 28, via thermal activation (e.g., during step 214), or other processes. At step 218, the process 200 may further include dissolving the spacer elements 46. For example, the spacer elements 46 may be dissolved under the same principles and at the same time as the inner seal 34 (e.g., step 216) or by other processes, for example, the inner seal 34 may be dissolved over time and the spacer elements 46 may be dissolved or otherwise broken down via thermal activation. However, it should be appreciated that, in some embodiments, the spacer elements 46 are more rigid than the inner seal 34, such that the dissolving process (if applicable) generally takes longer. Further, it should be appreciated that, in some implementations, the spacer elements 46 may be formed of a material that does not dissolve.

The disclosure herein is further summarized in the following paragraphs and is further characterized by combinations of any and all of the various aspects described therein.

According to one aspect of the present disclosure, an electro-optic element includes a first substrate that has a first surface and a second surface. A second substrate has a third surface and a fourth surface, the second substrate is disposed in a spaced apart relationship with the first substrate such that the second and third surfaces face one another. A first electrode is associated with the second surface and a second electrode is associated with the third surface. An electrochromic medium is disposed between the first and second electrodes. An outer seal is disposed between the first and second substrates in a peripheral manner to contain the electrochromic medium. The outer seal is substantially uniform and defines a completely closed loop.

According to another aspect, an outer seal has a substantially uniform cross-section along an entirety of the outer seal.

According to yet another aspect, an outer seal has a substantially homogeneous cross-section along an entirety of the outer seal.

According to still another aspect, an inner seal located internally to a loop defined by an outer seal.

According to still yet another aspect, an outer seal is formed of a first seal material and an inner seal formed of a second seal material different than the first seal material.

According to another aspect, the second seal material is dissolvable in an electrochromic medium.

According to yet another aspect, the first seal material is formed of material that is not dissolvable in the electrochromic material.

According to still another aspect, a plurality of spacer elements located within the cavity and in an inboard direction from the inner seal.

According to still yet another aspect, the spacer elements are formed of a spacer element material different than the first seal material and the second seal material.

According to another aspect, the spacer element material is capable of being broken down via thermal activation.

According to yet another aspect, an electrochromic medium includes traces of an inner seal material from an inner seal that has been dissolved within the electrochromic medium.

According to still another aspect, an electrochromic material includes an electrolyte.

According to still yet another aspect, a first electrode includes one of an anodic or a cathodic film and a second electrode includes a different one of the anodic and the cathodic films.

According to another aspect, the outer seal does not define a fill port or any breaks.

According to another aspect of the present disclosure, a window includes a first substrate that has a first surface and a second surface. A second substrate has a third surface and a fourth surface, the second substrate is disposed in a spaced apart relationship with the first substrate such that the second and third surfaces face one another. A first electrode is associated with the second surface and a second electrode is associated with the third surface. An electrochromic medium is disposed between the first and second electrodes. The electrochromic medium includes traces of an inner seal material that has been dissolved in the electrochromic medium. An outer seal formed of an outer seal material is disposed between the first and second substrates in a peripheral manner to contain the electrochromic medium. The outer seal is substantially uniform and defines a completely closed loop.

According to another aspect, an inner seal material is selected from a group consisting of an acrylic material dissolvable in the electrochromic medium or an epoxy material dissolvable in the electrochromic medium.

According to yet another aspect, the inner seal material includes a photo-crosslinked polymethyl methacrylate.

According to still another aspect, the inner seal material includes a SU-8 epoxy.

According to yet another aspect of the present disclosure, an electro-optic element includes a first substrate that has a first surface and a second surface. A second substrate has a third surface and a fourth surface, the second substrate is disposed in a spaced apart relationship with the first substrate such that the second and third surfaces face one another. A first electrode including an anodic film is associated with the second surface and a second electrode including a cathodic film is associated with the third surface. An electrochromic medium is disposed between the first and second electrodes. The electrochromic medium includes an electrolyte having traces of an inner seal material that has been dissolved in the electrochromic medium. An outer seal formed of an outer seal material is disposed between the first and second substrates in a peripheral manner to contain the electrochromic medium. The outer seal is substantially uniform and defines a completely closed loop.

According to another aspect, a first conductive layer is coupled to a first electrode and a second conductive layer is coupled to a second electrode.

According to yet another aspect, an inner seal material includes at least one of a photo-crosslinked polymethyl methacrylate or a SU-8 epoxy.

According to still yet another aspect of the present disclosure, a process for manufacturing an electro-optic element includes providing a substrate, disposing an inner seal in a peripheral manner on the substrate, and disposing an outer seal in a peripheral manner on the substrate. The inner seal is located within the outer seal. The process further includes disposing an electrochromic medium within the inner seal and disposing another substrate on top of the substrate, inner seal, outer seal, and electrochromic medium. The process further includes curing the outer seal.

According to another aspect, a process for manufacturing an electro-optic element includes dissolving the inner seal.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. An electro-optic element, comprising:
a first substrate having a first surface and a second surface;
a second substrate having a third surface and a fourth surface, the second substrate disposed in a spaced apart relationship with the first substrate such that the second and third surfaces face one another;
a first electrode associated with the second surface;
a second electrode associated with the third surface;
an electrochromic medium disposed between the first and second electrodes; and
an outer seal disposed between the first and second substrates in a peripheral manner to contain the electrochromic medium, the outer seal being substantially uniform and defining a completely closed loop.

2. The electro-optic element of claim 1, wherein the outer seal has a substantially uniform cross-section along an entirety of the outer seal.

3. The electro-optic element of claim 1, wherein the outer seal has a substantially homogeneous cross-section along an entirety of the outer seal.

4. The electro-optic element of claim 1, further comprising an inner seal located internally to the loop defined by the outer seal.

5. The electro-optic element of claim 4, wherein the outer seal is formed of a first seal material and the inner seal formed of a second seal material different than the first seal material.

6. The electro-optic element of claim 5, wherein the second seal material is dissolvable in the electrochromic medium.

7. The electro-optic element of claim 6, wherein the first seal material is formed of material that is not dissolvable in the electrochromic material.

8. The electro-optic element of claim 7, further including a plurality of spacer elements located within the cavity and in an inboard direction from the inner seal.

9. The electro-optic element of claim 8, wherein the plurality of spacer elements are formed of a spacer element material different than the first seal material and the second seal material.

10. The electro-optic element of claim 9, wherein the spacer element material is capable of being broken down via thermal activation.

11. The electro-optic element of claim 6, further comprising traces of a second seal material from an inner seal that has been dissolved within the electrochromic medium.

12. The electro-optic element of claim 6, wherein the electrochromic material includes an electrolyte.

13. The electro-optic element of claim 12, wherein the first electrode includes one of an anodic or a cathodic film and the second electrode includes a different one of the anodic and the cathodic films.

14. A window, comprising:
a first substrate having a first surface and a second surface;
a second substrate having a third surface and a fourth surface, the second substrate disposed in a spaced apart relationship with the first substrate such that the second and third surfaces face one another;
a first electrode associated with the second surface;
a second electrode associated with the third surface;
an electrochromic medium disposed between the first and second electrodes and including traces of an inner seal material that has been dissolved in the electrochromic medium; and
an outer seal formed of an outer seal material is disposed between the first and second substrates in a peripheral manner to contain the electrochromic medium and the traces of the inner seal material, the outer seal being substantially uniform and defining a completely closed loop.

15. The window of claim 14, wherein the inner seal material is selected from a group consisting of an acrylic material dissolvable in the electrochromic medium or an epoxy material dissolvable in the electrochromic medium.

16. The window of claim 15, wherein the inner seal material includes a photo-crosslinked polymethyl methacrylate.

17. The window of claim 15, wherein the inner seal material includes a SU-8 epoxy.

18. An electro-optic element, comprising:
a first substrate having a first surface and a second surface;
a second substrate having a third surface and a fourth surface, the second substrate disposed in a spaced apart relationship with the first substrate such that the second and third surfaces face one another;
a first electrode including an anodic film associated with the second surface;
a second electrode including a cathodic film associated with the third surface;
an electrochromic medium disposed between the first and second electrodes and including an electrolyte having traces of an inner seal material; and
an outer seal formed of an outer seal material is disposed between the first and second substrates in a peripheral manner to contain the electrochromic medium and the traces of the inner seal material, the outer seal being substantially uniform and defining a completely closed loop.

19. The electro-optic element of claim 18, further including a first conductive layer coupled to the first electrode and a second conductive layer coupled to the second electrode.

20. The electro-optic element of claim 18, wherein the inner seal material includes at least one of a photo-crosslinked polymethyl methacrylate or a SU-8 epoxy.
